(19) United States
(12) Patent Application Publication
(10) Pub. No.: US 2018/0287118 A1
(43) Pub. Date: Oct. 4, 2018

(54) SECONDARY BATTERY

(71) Applicant: PANASONIC INTELLECTUAL PROPERTY MANAGEMENT CO., LTD., Osaka (JP)

(72) Inventor: Masaki Hasegawa, Osaka (JP)

(73) Assignee: PANASONIC INTELLECTUAL PROPERTY MANAGEMENT CO., LTD., Osaka (JP)

(21) Appl. No.: 15/997,984

(22) Filed: Jun. 5, 2018

Related U.S. Application Data
(63) Continuation of application No. PCT/JP2016/005123, filed on Dec. 14, 2016.

(30) Foreign Application Priority Data
Dec. 25, 2015 (JP) 2015-253569
Mar. 28, 2016 (JP) 2016-064182

(51) Int. Cl. H01M 2/12; H01M 10/0525; H01M 10/0569; H01M 4/525; H01M 4/505

(52) U.S. Cl. CPC H01M 2/1282; H01M 10/0525; H01M 10/0569; H01M 2300/0037; H01M 4/505; H01M 2300/0042; H01M 2300/004; H01M 4/525

(57) ABSTRACT

A nonaqueous electrolyte secondary battery is provided with: a cathode; an anode; a nonaqueous electrolyte containing a nonaqueous solvent; an outer packaging for accommodating the cathode, the anode, and the nonaqueous electrolyte; and a pressure release valve for reducing the internal pressure of the outer packaging, said valve being actuated at a battery temperature of 145° C. or less when the battery temperature rises.

### TECHNICAL FIELD

The present disclosure relates to a technique for a nonaqueous electrolyte secondary battery.

### BACKGROUND ART

In recent years, a nonaqueous electrolyte secondary battery using, as a positive electrode active material, a Ni-, Co-, Mn- and Li-containing transition metal oxide has been known as a battery having a high energy density and high thermal stability (see, for example, Patent Literature 1).

In a nonaqueous electrolyte secondary battery, if a battery temperature excessively increases due to, for example, some external factor, a solvent or the like of a nonaqueous electrolyte is electrolyzed to generate a gas, which may increase the internal pressure of the battery in some cases. Therefore, the nonaqueous electrolyte secondary battery is generally provided with a current interrupt device (CID) for interrupting a charging current when the internal pressure of the battery exceeds a prescribed value or a pressure relief valve for lowering the internal pressure of a package, and thus, the safety of the battery is attained (see, for example, Patent Literature 2).

### CITATION LIST

### Patent Literature

Patent Literature 1: Japanese Patent Laid-Open Publication No. 2007-095443

Patent Literature 2: Japanese Patent Laid-Open Publication No. 2008-034391

### SUMMARY OF INVENTION

### Technical Problem

In case of a conventional pressure relief valve, the temperature of the battery may increase in some cases even after the pressure relief valve is actuated. As a result, in a battery module including a combination of a plurality of batteries, it is apprehended that other batteries adjacent to the battery having a high temperature may be harmfully affected.

An object of the present disclosure is to provide a nonaqueous electrolyte secondary battery capable of inhibiting excessive temperature increase of the battery after a pressure relief valve is actuated.

### Solution to Problem

A nonaqueous electrolyte secondary battery according to one aspect of the present disclosure includes a positive electrode, a negative electrode, a nonaqueous electrolyte containing a nonaqueous solvent, a package housing the positive electrode, the negative electrode and the nonaqueous electrolyte, and a pressure relief valve actuated at a battery temperature of 145° C. or less for lowering an internal pressure of the package when the battery temperature increases.

### Advantageous Effects of Invention

According to the nonaqueous electrolyte secondary battery of the one aspect of the present disclosure, excessive temperature increase of the battery can be inhibited after the pressure relief valve is actuated.

### BRIEF DESCRIPTION OF DRAWINGS

FIG. 1 is a schematic sectional view of a nonaqueous electrolyte secondary battery corresponding to an example of an embodiment of the present disclosure.

FIG. 2 is a diagram illustrating battery temperature increase curves of batteries A1 to A10 obtained in an ARC test.

FIG. 3 is a diagram illustrating the relationship between a 180° C. reaching time delay rate and an actuation temperature of a pressure relief valve in each of the batteries A1 to A10 obtained in the ARC test.

FIG. 4 is a diagram illustrating the relationship between the 180° C. reaching time delay rate and the actuation temperature of a pressure relief valve in each of batteries A11 to A14 obtained in the ARC test.

### DESCRIPTION OF EMBODIMENTS

(Finding Corresponding to Base of Present Disclosure)

A conventional pressure relief valve is designed mainly in consideration of an internal pressure of a package (an internal pressure of a battery) with no consideration given to a battery temperature. The present inventors earnestly examined the relationship between a battery temperature at the time when a pressure relief valve is actuated and increase in the battery temperature occurring after it is actuated, and as a result, have found that if the battery temperature is high at the time when the pressure relief valve is actuated, the battery temperature also increases after it is actuated and reaches a high temperature. Based on this finding, the present inventors have conceived the following aspect of the present invention.

A nonaqueous electrolyte secondary battery according to one aspect of the present disclosure includes a positive electrode, a negative electrode, a nonaqueous electrolyte containing a nonaqueous solvent, a package housing the positive electrode, the negative electrode and the nonaqueous electrolyte, and a pressure relief valve actuated at a battery temperature of 145° C. or less for lowering a pressure within the package when the battery temperature increases. According to the one aspect of the present disclosure, the pressure relief valve is actuated before the battery temperature exceeds 145° C. at the time of increase in the battery temperature, so as to lower the battery temperature when the pressure within the package is released, and therefore, temperature increase caused by, for example, self-heating occurring due to a chemical reaction caused in the battery is suppressed so that excessive temperature increase of the battery can be inhibited.

Hereinafter, an example of a nonaqueous electrolyte secondary battery according to the one aspect of the present disclosure will be described. A drawing referred to in the description of an embodiment is illustrated merely schematically, and a dimensional proportion and the like of constituting elements illustrated in the drawing may be different from actual ones in some cases.

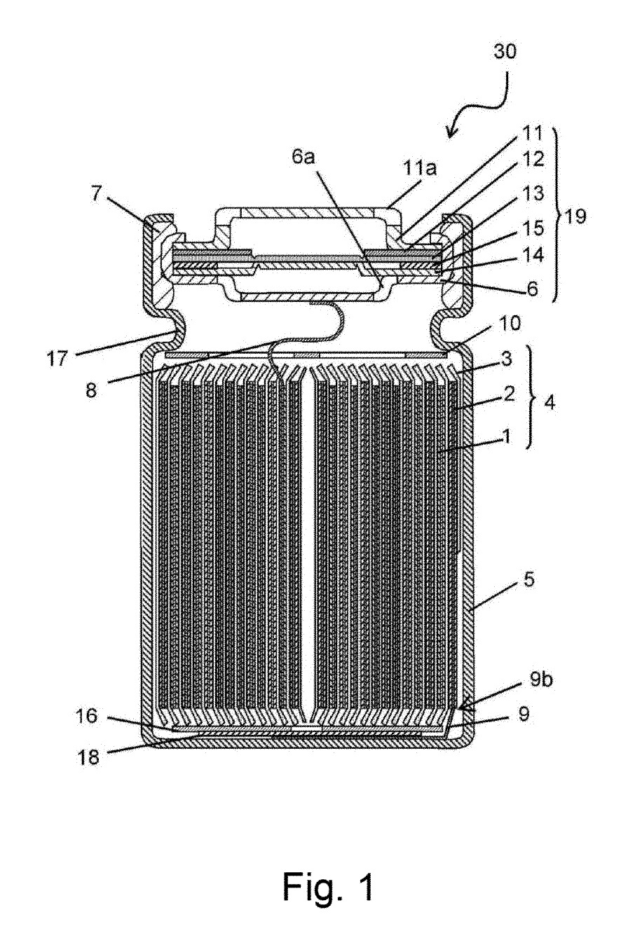

FIG. 1 is a schematic sectional view of an example of the structure of a nonaqueous electrolyte secondary battery of the present embodiment. A nonaqueous electrolyte secondary battery 30 of FIG. 1 includes an electrode body 4, which is a roll of a positive electrode 1, a negative electrode 2 and a separator 3 disposed between the positive electrode 1 and the negative electrode 2, and a package. Although the nonaqueous electrolyte secondary battery 30 of FIG. 1 is a cylindrical battery including the rolled electrode body 4, the shape of the battery is not especially limited, and the battery can be a rectangular battery, a flat battery or the like.

The package of the nonaqueous electrolyte secondary battery 30 of FIG. 1 includes a battery case 5, an outer gasket 7 and a sealing plate 19. The electrode body 4 is placed in the battery case 5 together with a nonaqueous electrolyte (an electrolyte solution) not shown. An opening of the battery case 5 is sealed with the sealing plate 19 with the outer gasket 7 disposed therebetween. Thus, the electrode body 4 and the nonaqueous electrolyte are housed in a sealed state within the package.

In the nonaqueous electrolyte secondary battery 30 of FIG. 1, an upper insulating plate 10 is disposed on an upper side of the electrode body 4, and a lower insulating plate 16 is disposed on a lower side of the electrode body 4. Incidentally, the upper insulating plate 10 is supported by a groove 17 of the battery case 5, and the electrode body 4 is fixed by the upper insulating plate 10.

The sealing plate 19 of FIG. 1 includes a terminal plate 11, a thermistor plate 12, a pressure relief valve 13, a current cut-off valve 14, a filter 6 and an inner gasket 15. The terminal plate 11, the thermistor plate 12 and the pressure relief valve 13 are connected to one another in peripheral portions thereof. Besides, the pressure relief valve 13 and the current cut-off valve 14 are connected to each other in center portions thereof. Furthermore, the current cut-off valve 14 and the filter 6 are connected to each other in peripheral portions thereof. In other words, the terminal plate 11 and the filter 6 are constructed to be electrically connected to each other.

The positive electrode 1 is connected to the filter 6 via a positive electrode lead 8, and the terminal plate 11 serves as an external terminal of the positive electrode 1. On the other hand, the negative electrode 2 is connected to a bottom of the battery case 5 via a negative electrode lead 9, and the battery case 5 serves as an external terminal of the negative electrode 2. In the battery 30 of FIG. 1, a metal plate 18 is disposed on the negative electrode lead 9. In welding the negative electrode lead 9 to the bottom of the battery case 5, the negative electrode lead 9 disposed on the bottom of the battery case 5 can be wholly welded to the bottom of the battery case 5 by pressing a weld electrode against the metal plate 18 and applying a voltage thereto.

The current cut-off valve 14 of FIG. 1 has a circular groove formed in a center portion thereof, and has such a structure that it is opened with a valve hole formed therein when the groove is broken. For example, if the internal pressure of the package (the internal pressure of the battery 30) increases due to a gas generated through electrolysis or the like of the electrolyte solution simultaneously with increase in the battery temperature in case of overcharge or the like, the current cut-off valve 14 is actuated (for example, in such a manner that the groove of the current cut-off valve 14 is broken), and the current cur-off valve 14 and the pressure relief valve 13 are disconnected from each other, and thus, a current path in the battery 30 is cut off. Incidentally, the current cut-off valve 14 is not limited to the structure and the position illustrated in FIG. 1 but may employ any structure and position capable of cutting off a current in accordance with the pressure increase within the package. Besides, there is no need to always provide the current cut-off valve 14.

The pressure relief valve 13 of FIG. 1 has a circular groove formed in a center portion thereof, and has such a structure that it is opened with a valve hole formed therein when the groove is broken. For example, if the internal pressure of the package (the internal pressure of the battery 30) increases due to a gas generated through the electrolysis or the like of the electrolyte solution simultaneously with the increase in the battery temperature in case of overcharge or the like, the pressure relief valve 13 is actuated (for example, in such a manner that the groove of the pressure relief valve 13 is broken or the pressure relief valve is bent to form a gap from the package). Thus, the gas generated within the battery 30 is discharged through a through hole 6a provided in the filter 6, the valve holes of the current cut-off valve 14 and the pressure relief valve 13 and an open portion 11a provided in the terminal plate 11 to the outside of the battery, so as to lower the internal pressure of the package. The pressure relief valve 13 is not limited to the structure and the position illustrated in FIG. 1 but may employ any structure and position capable of lowering the pressure within the package. For example, the pressure relief valve 13 may be disposed in the terminal plate 11 so as to cover the open portion 11a provided in the terminal plate 11. Besides, the pressure relief valve 13 may be in the shape of a thin plate or the like having no groove, for example.

An actuation temperature of the pressure relief valve 13 is 145° C. or less, preferably 140° C. or less, and more preferably 130° C. or less. The pressure relief valve 13 is preferably actuated at 100° C. or more. In other words, when the battery temperature increases due to abnormality or the like of the overcharge or the like, the pressure relief valve 13 is actuated before the battery temperature exceeds 145° C. (at 145° C. or less), preferably before it exceeds 140° C. (at 140° C. or less), and more preferably in a temperature region of 130° C. or less (for example, in such a manner that it is opened by an internal pressure of the package increased by the battery temperature), and thus, the gas inside the package is released to lower the internal pressure.

When the actuation temperature of the pressure relief valve 13 is 145° C. or less, excessive temperature increase of the battery otherwise caused after the pressure relief valve is actuated 13 can be inhibited. Incidentally, from the viewpoint of a temperature range for use of the battery and the like, the actuation temperature of the pressure relief valve 13 is set preferably to 100° C. or more.

The actuation temperature of the pressure relief valve 13 can be controlled by adjusting, for example, the thickness or the groove depth of the pressure relief valve. Specifically, when pressure resistance of the pressure relief valve is lowered by reducing the thickness of the pressure relief valve or making the groove deep, the actuation temperature can be lowered. In battery design, however, not only there is a limit in the adjustment of the thickness of the pressure relief valve and the groove depth but also a valve actuation temperature is varied depending on another design parameter, and therefore, it may be difficult to control the actuation temperature of the pressure relief valve 13 to 145° C. or less in some cases by using merely these parameters. Therefore, the battery is designed preferably based on the following parameters:

a=Remaining space ratio obtained by expression (2)/Pressure resistance of pressure relief valve (kgf/cm²) Expression (1)

Remaining space ratio=Space remaining within battery (cm³)/Rated capacity (Ah) of nonaqueous electrolyte secondary battery Expression (2)

The pressure resistance of the pressure relief valve of expression (1) corresponds to the internal pressure of the package at the time when the pressure relief valve 13 is actuated (for example, at the time of the valve opening), and is a value measured under hydrostatic pressure. The space remaining within the battery of expression (2) is a value obtained by subtracting, from the internal volume of the package, volumes of all the components, such as the electrode body 4, housed in the package, and is measured according to Archimedes' principle.

In the nonaqueous electrolyte secondary battery 30 using the positive electrode active material containing a Ni-, Co-, Al- and Li-containing transition metal oxide, the value “a” obtained by expression (1) is preferably 6.5 or less, more preferably 6 or less, and further preferably 5.0 or more and 5.8 or less. When the value “a” obtained by expression (1) is 6.5 or less, the actuation temperature of the pressure relief valve 13 can be easily controlled to 145° C. or less. Incidentally, in the nonaqueous electrolyte secondary battery 30 using the positive electrode active material containing the Ni-, Co-, Al- and Li-containing transition metal oxide, the rated capacity of the nonaqueous electrolyte secondary battery of expression (2) is a battery capacity obtained when the battery is discharged at 0.2 C in a voltage range of 2.5 V to 4.2 V.

In the nonaqueous electrolyte secondary battery 30 using the positive electrode active material containing a Ni-, Co-, Mn- and Li-containing transition metal oxide, the value “a” obtained by expression (1) is preferably 9.5 or less, and more preferably 9.2 or less. When the value “a” obtained by expression (1) is 9.5 or less, the actuation temperature of the pressure relief valve 13 can be easily controlled to 145° C. or less. Incidentally, in the nonaqueous electrolyte secondary battery 30 using the positive electrode active material containing the Ni-, Co-, Mn- and Li-containing transition metal oxide, the rated capacity of the nonaqueous electrolyte secondary battery of expression (2) is a battery capacity obtained when the battery is discharged at 0.2 C in a voltage range of 3.0 V to 4.1 V.

The pressure resistance of the pressure relief valve is preferably in a range of 20 kgf/cm² or more and 38 kgf/cm² or less, and more preferably in a range of 24 kgf/cm² or more and 34 kgf/cm² or less from the viewpoint of avoiding damage of the pressure relief valve 13 caused by impact, vibration or the like.

The remaining space ratio obtained by expression (2) is preferably in a range of 0.120 or more and 0.330 or less from the viewpoint of the rated capacity, the amount of the electrolyte solution and the like. In the nonaqueous electrolyte secondary battery 30 using the positive electrode active material containing the Ni-, Co-, Al- and Li-containing transition metal oxide, the remaining space ratio obtained by expression (2) is more preferably in a range of 0.160 or more and 0.230 or less. In the nonaqueous electrolyte secondary battery 30 using the positive electrode active material containing the Ni-, Co-, Mn- and Li-containing transition metal oxide, the remaining space ratio obtained by expression (2) is more preferably in a range of 0.220 or more and 0.320 or less.

The space remaining within the battery is determined in accordance with the size of the electrode body 4, the injection volume of the nonaqueous electrolyte, the internal volume of the package and the like. The space remaining within the battery may be appropriately set so that a desired remaining space ratio can be obtained, and is preferably in a range of 0.5 cm³ or more and 1.3 cm³ or less from the viewpoint of the amount of the electrolyte solution and the like. In the nonaqueous electrolyte secondary battery 30 using the positive electrode active material containing the Ni-, Co-, Al- and Li-containing transition metal oxide, the space remaining within the battery is more preferably in a range of 0.7 cm³ or more and 1.0 cm³ or less. In the nonaqueous electrolyte secondary battery 30 using the positive electrode active material containing the Ni-, Co-, Mn- and Li-containing transition metal oxide, the space remaining within the battery is more preferably in a range of 0.9 cm³ or more and 1.2 cm³ or less.

The positive electrode 1 is made of a positive electrode collector of, for example, a metal foil or the like, and a positive electrode active material layer formed on the positive electrode collector. As the positive electrode collector, a foil of a metal stable in a range of a positive electrode potential, such as aluminum, or a film or the like having the metal as a surface layer can be used.

The positive electrode active material layer contains the positive electrode active material, and in addition, suitably contains a conductive material and a binder. The positive electrode active material is not limited to single use of a Ni-, Co-, Mn- and Li-containing transition metal oxide, but a different positive electrode material may be used together. An example of the different positive electrode material includes lithium cobalt oxide capable of insertion and extraction of lithium ions with a stable crystal structure kept. Besides, particle surfaces of the positive electrode active material may be covered with fine particles of an oxide such as aluminum oxide (Al₂O₃) or an inorganic compound such as a phosphoric acid compound or a boric acid compound.

The positive electrode active material preferably contains a lithium-containing transition metal oxide represented by general formula, LiₓNi_{1-y}M_{y}O₂ (wherein 0<x<1.1, y≤0.7, and M represents an element excluding Li and Ni). An example of M includes at least one element out of Na, Mg, Sc, Y, Mn, Fe, Co, Ni, Cu, Zn, Al, Cr, Pb, Sb, B, Zr and W. From the viewpoint of stability in the crystal structure and the like, at least one element out of Co and Al is preferably contained. The composition ratio y is preferably 0.4 or more and 0.7 or less, and more preferably 0.45 or more and 0.6 or less.

When a Ni-, Co-, Mn- and Li-containing transition metal oxide represented by general formula, LiₓNi_{1-y}Co_{β}Mn_{γ}M_{δ}O₂ (wherein M represents an element excluding Li, Ni, Co and Mn) is used as the positive electrode active material, a sum of β, γ and β is y. In other words, y=β+γ+δ. The composition ratio β is preferably 0.1 or more and 0.4 or less, and more preferably 0.15 or more and 0.3 or less. The composition ratio y is preferably 0.2 or more and 0.4 or less, and more preferably 0.2 or more and 0.35 or less. The composition ratio δ is preferably 0 or more and 0.1 or less, and more preferably 0.001 or more and 0.015 or less.

The positive electrode active material preferably contains one element selected from Zr and W. The Zr and W contained in the positive electrode active material may be present, for example, in a solid solution state in the Li-containing transition metal oxide or the like, or a compound of Zr and W may be present in an adhering state to particle surfaces of the Li-containing transition metal oxide or the like. In either state, a content of the Zr and W in the positive electrode active material is preferably in a range of 0.1% by mole or more and 1.5% by mole or less, and more preferably in a range of 0.2% by mole or more and 0.7% by mole or less. When the content of the Zr and W satisfies the above-described range, the thermal stability is improved as compared with a case where it is out of the range, and therefore, for example, the actuation temperature of the pressure relief valve can be easily controlled to 140° C. or less. The content of the Zr and W in the positive electrode active material is a value obtained by dissolving the positive electrode active material in hydrochloric acid, and measuring the amount of Zr and W in the thus obtained solution by ICP atomic emission spectroscopy.

In general, a lithium-containing transition metal oxide containing Ni is rather poor in the thermal stability in a charged state as compared with a lithium-containing transition metal oxide principally containing Mn, Fe or Co, and hence, the battery temperature is easily increased. In the present embodiment, however, even when a lithium-containing transition metal oxide thus having lower thermal stability is used, the excessive temperature increase of the battery can be effectively inhibited.

The conductive material is used for improving electrical conductivity of the positive electrode active material layer. Examples of the conductive material include carbon materials such as carbon black, acetylene black, ketjen black and graphite. One of these may be singly used, or two or more of these may be used in combination.

The binder is used for keeping a good contact state between the positive electrode active material and the conductive material, and for improving a binding property of the positive electrode active material or the like to the surface of the positive electrode collector. Examples of the binder include polytetrafluoroethylene (PTFE), polyvinylidene fluoride (PVdF) and modified products of these. The binder may be used together with a thickener such as carboxymethylcellulose (CMC) or polyethylene oxide (PEO). One of these may be singly used, or two or more of these may be used in combination.

The negative electrode 2 includes a negative electrode collector of, for example a metal foil or the like, and a negative electrode active material layer formed on the negative electrode collector. As the negative electrode collector, a foil of a metal stable in a range of a negative electrode potential, such as copper, or a film or the like having, as a surface layer, a metal stable in the range of the negative electrode potential, such as copper, can be used. The negative electrode active material layer suitably contains a binder in addition to a negative electrode active material capable of absorption/desorption of lithium ions. As the binder, PTFE or the like can be used in the same manner as in the positive electrode, and a styrene-butadiene copolymer (SBR) or a modified product thereof is preferably used. The binder may be used together with a thickener such as CMC.

As the negative electrode active material, for example, natural graphite, artificial graphite, lithium, silicon, carbon, tin, germanium, aluminum, lead, indium, gallium, a lithium alloy, carbon and silicon in which lithium is previously absorbed, and an alloy or a mixture of any of these can be used.

As the separator 3, for example, a porous sheet having ion permeability and an insulating property is used. Specific examples of the porous sheet include a microporous thin film, woven fabric and nonwoven fabric. A material of the separator preferably contains, for example, a polyolefin such as polyethylene or polypropylene.

The nonaqueous electrolyte contains the nonaqueous solvent, and an electrolyte salt dissolved in the nonaqueous solvent. The nonaqueous solvent contains a fluorine-containing organic compound, and a content of the fluorine-containing organic compound is preferably 5% by volume or more and 15% by volume or less, and more preferably 10% by volume or more and 15% by volume or less with respect to a total volume of the nonaqueous solvent. When the content of the fluorine-containing organic compound is 5% by volume or more and 15% by volume or less, the actuation temperature of the pressure relief valve 13 can be easily controlled to 145° C. or less. Incidentally, when the content of the fluorine-containing organic compound is less than 5% by volume, a gas is difficult to generate simultaneously with the increase in the battery temperature as compared with a case where the content satisfies the above-described range, and the actuation temperature of the pressure relief valve 13 may be difficult to control to 145° C. or less in some cases. Alternatively, when the fluorine-containing organic compound exceeds 15% by volume, an amount of a decomposition product of the fluorine-containing organic compound produced at a high temperature increases as compared with the case where the content satisfies the above-described range, and battery performance may be degraded in some cases.

Examples of the fluorine-containing organic compound include a fluorinated cyclic carbonate, a fluorinated open-chain carbonate and a fluorinated open-chain ester.

Examples of the fluorinated cyclic carbonate include fluoroethylene carbonate (FEC), 4,5-difluoro-1,3-dioxolan-2-one, 4,4-difluoro-1,3-dioxolan-2-one, 4-fluoro-5-methyl-1,3-dioxolan-2-one, 4-fluoro-4-methyl-1,3-dioxolan-2-one, 4-trifluoromethyl-1,3-dioxolan-2-one and 4,5-difluoro-4,5-dimethyl-1,3-dioxolan-2-one (DFBC). Among these, FEC is preferred, for example, from the viewpoint that an amount of hydrofluoric acid generated at a high temperature can be suppressed.

Examples of the fluorinated open-chain carbonate include short open-chain carbonates, such as dimethyl carbonate, ethyl methyl carbonate, diethyl carbonate, methyl propyl carbonate, ethyl propyl carbonate and methyl isopropyl carbonate, in which part of the hydrogen atoms is substituted by fluorine atoms. Among these, fluorinated ethyl methyl carbonate (FEMC) is preferred, for example, from the viewpoint that the amount of hydrofluoric acid generated at a high temperature is suppressed, and in particular, 2,2,2-trifluoroethyl methyl carbonate is particularly preferred.

Examples of the fluorinated open-chain ester include short open-chain carboxylates, such as methyl acetate, ethyl acetate, propyl acetate, methyl propionate and ethyl propionate, in which part or all of the hydrogen atoms is substituted by fluorine atoms. More specific examples include ethyl 2,2,2-trifluoroacetate, methyl 3,3,3-trifluoropropionate (FMP) and methyl pentafluoropropionate, and for example, from the viewpoint that the amount of hydrofluoric acid generated at a high temperature is suppressed, FMP is preferred.

The nonaqueous solvent may contain, for example, a non-fluorinated solvent in addition to the fluorinated open-chain carbonate and the fluorinate open-chain ester. As the non-fluorinated solvent, any of cyclic carbonates such as ethylene carbonate, propylene carbonate, butylene carbonate and vinylene carbonate, open-chain carbonates such as dimethyl carbonate, ethyl methyl carbonate and diethyl carbonate, compounds containing esters such as methyl acetate, ethyl acetate, propyl acetate, methyl propionate, ethyl propionate and γ-butyrolactone, a compound containing a sulfone group such as propane sultone, compounds containing ethers such as 1,2-dimethoxyethane, 1,2-diethoxyethane, tetrahydrofuran, 1,2-dioxane, 1,4-dioxane and 2-methyl tetrahydrofuran, compounds containing nitriles such as butyronitrile, valeronitrile, n-heptanenitrile, succinonitrile, glutaronitrile, adiponitrile, pimelonitrile, 1,2,3-propanetricarbonitrile and 1,3,5-pentanetricarbonitrile, and a compound containing an amide such as dimethylformamide can be used.

The electrolyte salt contained in the nonaqueous electrolyte is preferably a lithium salt. As the lithium salt, any of those generally used as supporting salts in conventional nonaqueous electrolyte secondary batteries can be used. Specific examples include LiPF₆, LiBF₄, LiAsF₆, LiClO₄, LiCF₃SO₃, LiN(FSO₂)₂, LiN(C₁F₂ₗ₊₁SO₂)(CₘF₂ₘ₊₁SO₂) (wherein l and m are integers of 1 or more), LiC(CₚF₂ₚ₊₁SO₂)(C_{q}F_{2q+1}SO₂)(CᵣF₂ᵣ₊₁SO₂) (wherein p, q and r are integers of 1 or more), Li[B(C₂O₄)₂] (lithium bis(oxalato)borate (LiBOB)), Li[B(C₂O₄)F₂], Li[P(C₂O₄)F₄] and Li[P(C₂O₄)₂F₂]. One of these lithium salts may be singly used, or two or more of these may be used in combination.

### EXAMPLES

Hereinafter, the present disclosure will be further described with reference to Examples, but the present disclosure is not limited to these Examples.

### Experimental Example 1

[Preparation of Positive Electrode]

A mixture containing 100% by mass of LiNi_{0.82}CO_{0.15}Al_{0.03}O₂, 1.0% by mass of acetylene black and 0.9% by mass of polyvinylidene fluoride was obtained, and the mixture was kneaded with N-methyl-2-pyrrolidone to obtain a slurry. Thereafter, the slurry was applied on an aluminum foil collector used as a positive electrode collector, and the resultant was dried and then rolled out to prepare a positive electrode.

[Preparation of Negative Electrode]

A mixture containing 100% by mass of graphite, 1% by mass of a carboxymethylcellulose sodium salt and 1% by mass of a styrene-butadiene copolymer was obtained, and the mixture was kneaded with water to obtain a slurry. Thereafter, the slurry was applied on a copper foil collector used as a negative electrode collector, and the resultant was dried and then rolled out to prepare a negative electrode.

[Preparation of Nonaqueous Electrolyte]

A mixed solvent was adjusted to contain 10% by volume of fluoroethylene carbonate (FEC), 5% by volume of ethylene carbonate (EC), 5% by volume of propylene carbonate (PC), 40% by volume of ethyl methyl carbonate (EMC) and 40% by volume of dimethyl carbonate (DMC), and to the resultant solvent, LiPF₆ was added to a concentration of 1.2 mol/l to prepare a nonaqueous electrolyte.

[Preparation of Battery]

An aluminum positive electrode lead was welded to the positive electrode, and a nickel negative electrode lead was welded to the negative electrode. Thereafter, the positive electrode, the negative electrode and a separator were rolled up to obtain a rolled electrode body. Insulating plates were disposed on upper and lower surfaces of the thus obtained rolled electrode body, the electrode body was inserted into a battery can in a bottomed cylindrical shape, and the positive electrode lead and the negative electrode lead were respectively welded to a sealing body and the battery can. Subsequently, the nonaqueous electrolyte was injected into the battery can, the sealing body was fixed by caulking using an insulating gasket, and thus, a cylindrical lithium ion secondary battery was prepared. The sealing body was provided with a pressure relief valve and a current cut-off valve as illustrated in FIG. 1. As the current cut-off valve, a current cut-off valve having pressure resistance of 15 kgf/cm² (a current cut-off valve cutting off a current when a package internal pressure was increased to 15 kgf/cm²) was used. As the pressure relief valve, a pressure relief valve having pressure resistance of 29 kgf/cm² (a pressure relief valve opened when the package internal pressure was increased to 29 kgf/cm²) was used. A rated capacity of the secondary battery was 4200 mAh, and a space remaining within the battery was 0.84 cm³. The pressure resistance, the rated capacity and the space remaining within the battery were measured by the above-described methods. The resultant was designated as a battery A1.

In the battery A1, the remaining space ratio obtained by expression (1) was 0.192, and the value “a” obtained by expression (2) was 5.57.

### Experimental Example 2

A battery was prepared in the same manner as in Experimental Example 1 except that a mixed solvent was adjusted to contain 15% by volume of fluoroethylene carbonate (FEC), 10% by volume of ethyl methyl carbonate (EMC) and 75% by volume of dimethyl carbonate (DMC). The resultant was designated as a battery A2. The remaining space ratio and the value “a” of the battery A2 were the same as those of the battery A1.

### Experimental Example 3

A battery was prepared in the same manner as in Experimental Example 1 except that a mixed solvent was adjusted to contain 15% by volume of fluoroethylene carbonate (FEC), 45% by volume of ethyl methyl carbonate (EMC) and 40% by volume of dimethyl carbonate (DMC). The resultant was designated as a battery A3. The remaining space ratio and the value “a” of the battery A3 were the same as those of the battery A1.

### Experimental Example 4

A battery was prepared in the same manner as in Experimental Example 1 except that a mixed solvent was adjusted to contain 15% by volume of fluoroethylene carbonate (FEC), 45% by volume of ethyl methyl carbonate (EMC) and 40% by volume of dimethyl carbonate (DMC) and that LiPF₆ was added to the resultant solvent to a concentration of 1.4 mol/l. The resultant was designated as a battery A4. The remaining space ratio and the value “a” of the battery A4 were the same as those of the battery A1.

### Experimental Example 5

A battery was prepared in the same manner as in Experimental Example 1 except that a mixed solvent was adjusted to contain 15% by volume of fluoroethylene carbonate (FEC), 65% by volume of ethyl methyl carbonate (EMC) and 20% by volume of dimethyl carbonate (DMC). The resultant was designated as a battery A5. The remaining space ratio and the value “a” of the battery A5 were the same as those of the battery A1.

### Experimental Example 6

A battery was prepared in the same manner as in Experimental Example 1 except that a mixed solvent was adjusted to contain 15% by volume of fluoroethylene carbonate (FEC) and 85% by volume of ethyl methyl carbonate (EMC). The resultant was designated as a battery A6. The remaining space ratio and the value “a” of the battery A6 were the same as those of the battery A1.

### Experimental Example 7

A battery was prepared in the same manner as in Experimental Example 1 except that the space remaining within the battery was set to 0.98 cm³, and that a mixed solvent was adjusted to contain 15% by volume of fluoroethylene carbonate (FEC) and 85% by volume of ethyl methyl carbonate (EMC). The resultant was designated as a battery A7. The space remaining within the battery was 0.98 cm³, the remaining space ratio obtained by expression (1) was 0.224, and the value “a” obtained by expression (2) was 6.50.

### Experimental Example 8

A battery was prepared in the same manner as in Experimental Example 7 except that a mixed solvent was adjusted to contain 7.5% by volume of fluoroethylene carbonate (FEC), 12.5% by volume of ethylene carbonate (EC) and 80% by volume of ethyl methyl carbonate (EMC). The resultant was designated as a battery A8. The remaining space ratio and the value “a” of the battery A8 were the same as those of the battery A7.

### Experimental Example 9

A battery was prepared in the same manner as in Experimental Example 7 except that a mixed solvent was adjusted to contain 5% by volume of fluoroethylene carbonate (FEC), 15% by volume of ethylene carbonate (EC) and 80% by volume of ethyl methyl carbonate (EMC). The resultant was designated as a battery A9. The remaining space ratio and the value “a” of the battery A9 were the same as those of the battery A7.

### Experimental Example 10

A battery was prepared in the same manner as in Experimental Example 1 except that a mixed solvent was adjusted to contain 20% by volume of ethylene carbonate (EC), 5% by volume of ethyl methyl carbonate (EMC) and 75% by volume of dimethyl carbonate (DMC) and that LiPF₆ was added to the resultant solvent to a concentration of 1.4 mol/l. The resultant was designated as a battery A10. The space remaining within the battery was 1.05 cm³, the remaining space ratio obtained by expression (1) was 0.24, and the value “a” obtained by expression (2) was 6.96.

<ARC (Accelerating Rate Calorimeter) Test>

Each of the batteries A1 to A10 was charged with a constant current of 1000 mA to 4.1 V, and then subjected to ARC test under the following conditions. In the ARC test, an ARC test apparatus manufactured by Thermal Hazard Technology was used with a measurement start temperature set to 80° C., a measurement end temperature set to 200° C., an increment of the measurement temperature set to 10° C., and measurement sensitivity set to 0.02° C./min.

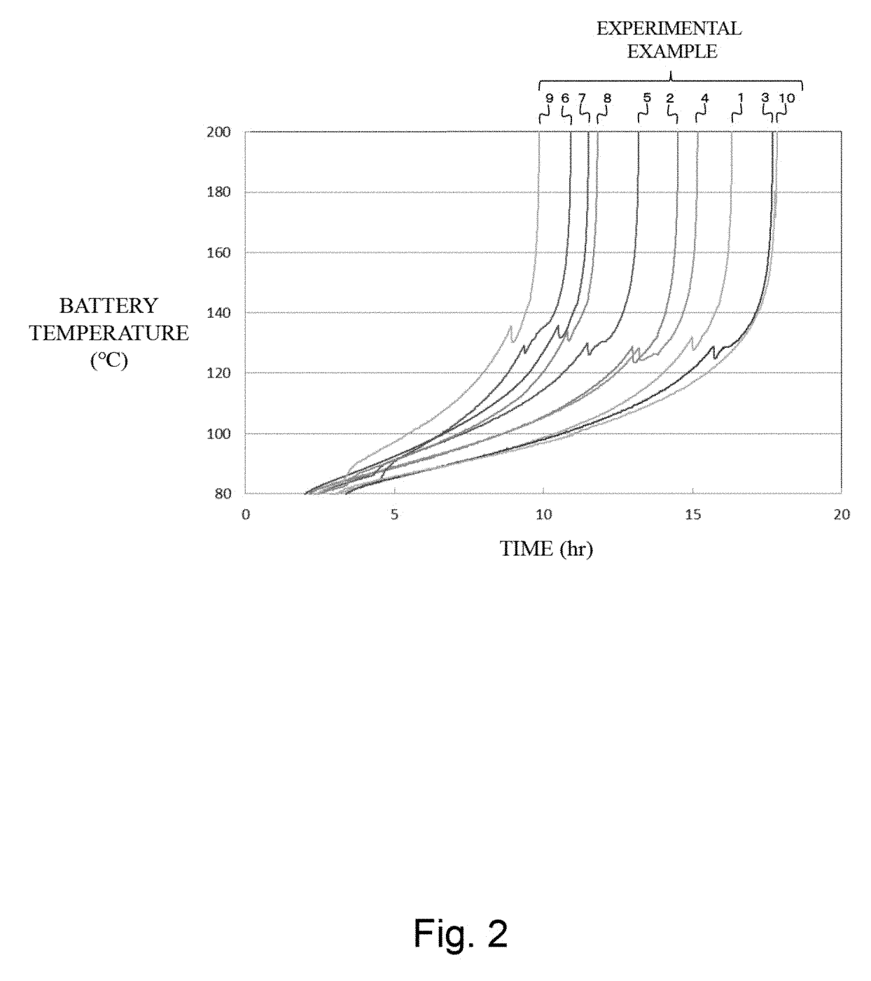

In the ARC test, a temperature sensor was disposed to be in contact with the package of the battery, and the battery temperature was measured from the start of the test (the start of temperature increase) until the battery temperature reached 200° C. The results are shown in FIG. 2.

FIG. 2 is a diagram illustrating battery temperature increase curves of the batteries A1 to A10 obtained in the ARC test. As illustrated in FIG. 2, in each of the batteries A1 to A9, the battery temperature increased as the temperature increase in the ARC test was started, and an inflection point at which the battery temperature once decreased was observed at a temperature of 145° C. or less. This inflection point reflects that the pressure relief valve provided in the battery is actuated (opened), and the temperature of the inflection point corresponds to the actuation temperature of the pressure relief valve. Incidentally, since temperature load was applied to the battery also after the pressure relief valve is actuated in the ARC test, the battery temperature also increased after the pressure relief valve is actuated (after the inflection point) as illustrated in FIG. 2. On the other hand, in the battery A10, an inflection point was observed in the vicinity of 180° C. The results of the actuation temperatures of the pressure relief valves of the batteries A1 to A10 (the temperatures of the inflection points illustrated in FIG. 2) are shown altogether in Table 1.

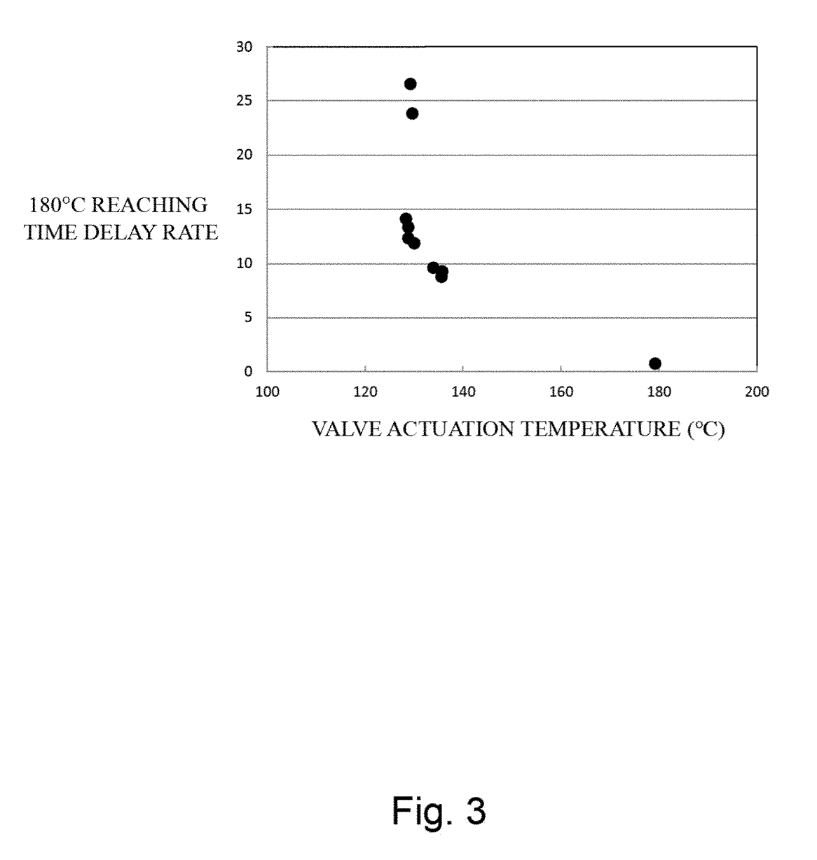

FIG. 3 is a diagram illustrating the relationship between a 180° C. reaching time delay rate and the actuation temperature of the pressure relief valve of each of the batteries A1 to A10 obtained in the ARC test. Here, the 180° C. reaching time delay rate refers to a value of an incremental rate, expressed in percentage, of time taken from 100° C. to 180° C. of each of the batteries A1 to A10 as compared with time taken from 100° C. to 180° C. of a corresponding one of batteries A1′ to A10′, which had the same structures as the batteries A1 to A10 except that the pressure relief valve was not included. A higher 180° C. reaching time delay rate means that the battery temperature, increased in the ARC test, took longer time to reach 180° C. In other words, a higher 180° C. reaching time delay rate means that the battery temperature increase due to self-heating of the battery was small and excessive heat generation of the battery was inhibited. The results of the 180° C. reaching time delay rate of the batteries A1 to A10 are shown altogether in Table 1.

TABLE 1

| | | | | Valve | 180° C. |
|---|---|---|---|---|---|
| | | | | Actuation | Reaching Time |
| | LiPF₆ | FEC | | Temperature | Delay Rate |
| | (mol/l) | (vol %) | a | (□) | (%) |
| Experimental | 1.2 | 10 | 5.57 | 129.2 | 26.56 |
| Example 1 | | | | | |
| Experimental | 1.2 | 15 | 5.57 | 128.8 | 12.34 |
| Example 2 | | | | | |
| Experimental | 1.2 | 15 | 5.57 | 128.8 | 13.36 |
| Example 3 | | | | | |
| Experimental | 1.4 | 15 | 5.57 | 128.3 | 14.14 |
| Example 4 | | | | | |
| Experimental | 1.2 | 15 | 5.57 | 130.0 | 11.88 |
| Example 5 | | | | | |
| Experimental | 1.2 | 15 | 5.57 | 129.6 | 23.84 |
| Example 6 | | | | | |
| Experimental | 1.2 | 15 | 6.50 | 135.7 | 9.28 |
| Example 7 | | | | | |
| Experimental | 1.2 | 7.5 | 6.50 | 133.9 | 9.61 |
| Example 8 | | | | | |
| Experimental | 1.2 | 5 | 6.50 | 135.6 | 8.79 |
| Example 9 | | | | | |
| Experimental | 1.4 | 0 | 6.96 | 179.2 | 0.75 |
| Example 10 | | | | | |

In the batteries A1 to A9, the pressure relief valves were actuated at a temperature of 145° C. or less. The batteries A1 to A9 had larger values of the 180° C. reaching time delay rate than the battery A10 with the pressure relief valve that was actuated at the battery temperature in the vicinity of 180° C. In other words, it can be said that when a pressure relief valve actuated at a battery temperature of 145° C. or less is used, excessive heat generation of the battery after it is actuated can be inhibited. Besides, when the value “a” obtained by expression (2) is preferably 6.5 or less and more preferably 6 or less, and the content of the fluorine-containing organic compound in the nonaqueous electrolyte is preferably 5% by volume or more and 15% by volume or less, and more preferably 10% by volume or more and 15% by volume or less, the actuation temperature of the pressure relief valve can be easily controlled to 145° C. or less, and preferably 140° C. or less.

Besides, in the batteries A1 to A6, the pressure relief valves were actuated at a temperature of 130° C. or less. The batteries A1 to A6 had higher 180° C. reaching time delay rates than the batteries A7 to A10 in which the actuation temperatures of the pressure relief valves were higher than 130° C. In other words, when a pressure relief valve actuated at a battery temperature of 130° C. or less is used, the excessive heat generation of the battery after it is actuated can be further inhibited.

### Experimental Example 11

A battery A11 described below was prepared in the same manner as in Experimental Example 1 except for a positive electrode and a nonaqueous electrolyte. The positive electrode and the nonaqueous electrolyte used in the battery A11 is described below.

[Preparation of Positive Electrode]

A mixture containing 96% by mass of LiNi_{0.5}Co_{0.2}Mn_{0.3}O₂, 2.5% by mass of acetylene black and 2.5% by mass of polyvinylidene fluoride was obtained, and the mixture was kneaded with N-methyl-2-pyrrolidone to obtain a slurry. Thereafter, the slurry was applied on an aluminum foil collector used as a positive electrode collector, and the resultant was dried and then rolled out to prepare a positive electrode.

[Preparation of Nonaqueous Electrolyte]

A nonaqueous electrolyte was prepared by adjusting a solvent to contain 10% by volume of fluoroethylene carbonate (FEC), 10% by volume of ethylene carbonate (EC), 5% by volume of propylene carbonate (PC), 40% by volume of ethyl methyl carbonate (EMC) and 35% by volume of dimethyl carbonate (DMC), and adding LiPF₆ to the resultant solvent to a concentration of 1.4 mol/l.

A rated capacity of the battery A11 was 3500 mAh, and the space remaining within the battery was 1.1 cm³.

In the battery A11, the remaining space ratio obtained by expression (2) was 0.316, and the value “a” obtained by expression (1) was 9.16.

### Experimental Example 12

A battery was prepared in the same manner as in Experimental Example 11 except that a mixed solvent was adjusted to contain 15% by volume of fluoroethylene carbonate (FEC), 5% by volume of propylene carbonate (PC), 10% by volume of ethyl methyl carbonate (EMC) and 70% by volume of dimethyl carbonate (DMC). The resultant was designated as a battery A12. The remaining space ratio and the value “a” of the battery A12 were the same as those of the battery A11.

### Experimental Example 13

A battery was prepared in the same manner as in Experimental Example 11 except that a positive electrode active material in which Zr was contained as a solid solution in LiNi_{0.5}Co Mn_{0.30}O₂ was used. A content of Zr in the positive electrode active material used in this experimental example was 0.5% by mole. The resultant was designated as a battery A13. The remaining space ratio and the value “a” of the battery A13 were the same as those of the battery A11.

### Experimental Example 14

A battery was prepared in the same manner as in Experimental Example 11 except that the remaining space ratio was changed. The resultant was designated as a battery A14. The remaining space ratio obtained by expression (2) was 0.324, and the value “a” obtained by expression (1) was 9.39.

Each of the batteries A11 to A14 was charged with a constant current of 840 mA to 4.1 V, and then subjected to the ARC test under the above conditions.

In each of the batteries A11 to A14, the battery temperature increased as the temperature increase in the ARC test was started, and an inflection point at which the battery temperature once decreased was observed at a temperature of 145° C. or less. Besides, in the battery A14, an inflection point was observed at a temperature exceeding 140° C. The results of the actuation temperatures of the pressure relief valves of the batteries A11 to A14 are shown altogether in Table 2.

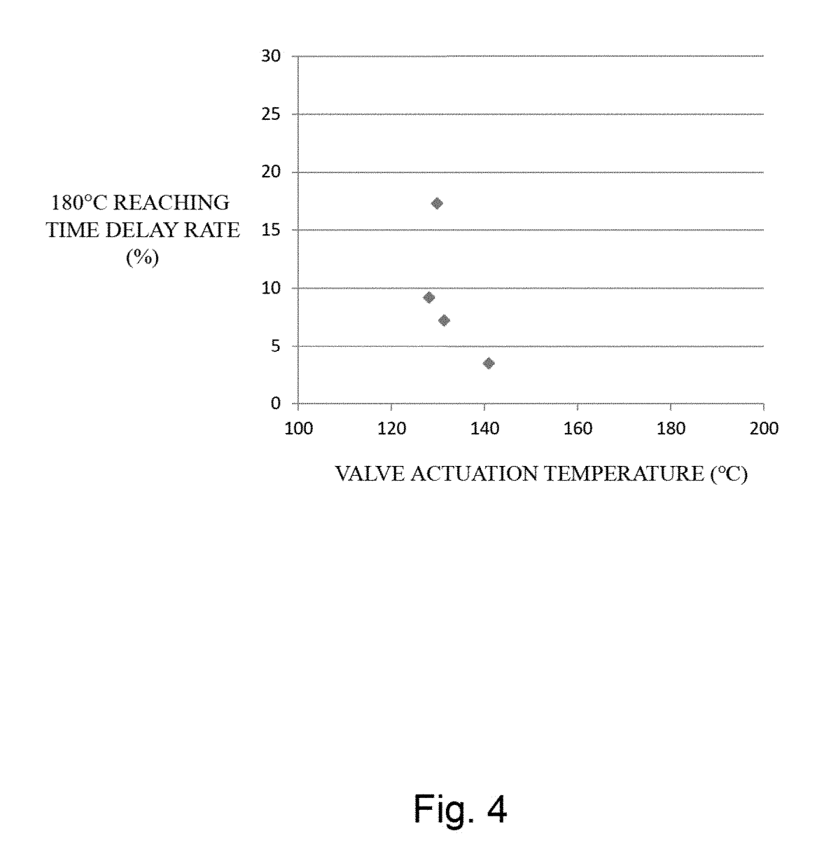

FIG. 4 is a diagram illustrating the relationship between the 180° C. reaching time delay rate and the actuation temperature of the pressure relief valve of each of the batteries A11 to A14 obtained in the ARC test. Here, the 180° C. reaching time delay rate refers to a value of an increase rate, expressed in percentage, of time taken from 100° C. to 180° C. of each of the batteries A11 to A14 as compared with time taken from 100° C. to 180° C. of a corresponding one of batteries A11′ to A14′, which had the same structures as the batteries A11 to A14 except that the pressure relief valve was not included. A higher 180° C. reaching time delay rate means that the battery temperature, increased in the ARC test, took longer time to reach 180° C. In other words, a higher 180° C. reaching time delay rate means that the battery temperature increase due to self-heating of the battery was small and excessive heat generation of the battery was inhibited. The results of the 180° C. reaching time delay rates of the batteries A11 to A14 are shown altogether in Table 2.

TABLE 2

| | | | | | | 180° C. |
|---|---|---|---|---|---|---|
| | | | | | Valve | Reaching |
| | | | | | Actuation | Time |
| | Zr | LiPF₆ | FEC | | Temperature | Delay |
| | (mol %) | (mol/l) | (vol %) | a | (□) | Rate (%) |
| Experimental | 0 | 1.4 | 10 | 9.16 | 131.3 | 7.22 |
| Example 11 | | | | | | |
| Experimental | 0 | 1.4 | 15 | 9.16 | 128.1 | 9.19 |
| Example 12 | | | | | | |
| Experimental | 0.5 | 1.4 | 10 | 9.16 | 129.8 | 17.30 |
| Example 13 | | | | | | |
| Experimental | 0 | 1.4 | 10 | 9.39 | 140.9 | 3.49 |
| Example 14 | | | | | | |

In the batteries A11 to A14, the pressure relief valves were actuated at a temperature of 145° C. or less. They had larger values of the 180° C. reaching time delay rate than the battery A10 with the pressure relief valve that was actuated at a temperature in the vicinity of 180° C. In other words, it can be said that when a pressure relief valve actuated at a battery temperature of 145° C. or less is used, excessive heat generation of the battery after it is actuated can be inhibited. Besides, when the value “a” obtained by expression (2) is 9.5 or less, the actuation temperature of the pressure relief valve can be easily controlled to 145° C. or less.

Besides, in the batteries A11 to A13, the pressure relief valves were actuated at a temperature of 140° C. or less. They had larger values of the 180° C. reaching time delay rate than the battery A14 with the pressure relief valve that was actuated at a temperature higher than 140° C. In other words, it can be said that when a pressure relief valve actuated at a battery temperature of 140° C. or less is used, excessive heat generation of the battery after it is actuated can be inhibited. Besides, when the value “a” obtained by expression (2) is 9.2 or less, the actuation temperature of the pressure relief valve can be easily controlled to 140° C. or less.

### INDUSTRIAL APPLICABILITY

The present disclosure is applicable to a nonaqueous electrolyte secondary battery.

### REFERENCE SIGNS LIST

1 positive electrode
2 negative electrode
3 separator
5 battery case
6 filter
6a through hole
7 outer gasket
8 positive electrode lead
9 negative electrode lead
10 upper insulating plate
11 terminal plate
11a open portion
12 thermistor plate
13 pressure relief valve
14 current cut-off valve
15 inner gasket
16 lower insulating plate
17 groove
18 metal plate
19 sealing plate
30 nonaqueous electrolyte secondary battery

1. A secondary battery comprising:
a positive electrode having a positive electrode active material containing a Ni-, Co- and Li-containing transition metal oxide;
a negative electrode;
an electrolyte;
a package housing the positive electrode, the negative electrode and the electrolyte; and
a pressure relief valve actuated at a battery temperature of 145° C. or less for lowering an internal pressure of the package when the battery temperature increases,
wherein a value “a” obtained by expression (1) is 9.5 or less:
a=Remaining space ratio obtained by expression (2)/Pressure resistance of pressure relief valve (kgf/cm²) Expression (1)
Remaining space ratio=Space remaining within battery cm³)/Rated capacity (Ah) of secondary battery Expression (2).

2. The secondary battery according to claim 1,
wherein the positive electrode active material containing the Ni-, Co- and Li-containing transition metal oxide is the positive electrode active material containing a Ni-, Co-, Al- and Li-containing transition metal oxide, and
the value “a” obtained by expression (1) is 6.5 or less.

3. The secondary battery according to claim 1,
wherein the positive electrode active material containing the Ni-, Co- and Li-containing transition metal oxide is the positive electrode active material containing a Ni-, Co-, Mn- and Li-containing transition metal oxide.

4. The secondary battery according to claim 3,
wherein the Ni-, Co-, Mn- and Li-containing transition metal oxide is represented by a general formula, LiₓNi_{1-y}Co_{β}Mn_{γ}M_{δ}O₂,
wherein 0<x<1.1, y≤0.7, y=β+δ, 0.1≤β≤0.4, 0.2≤γ≤0.4, 0≤δ≤0.1, and M represents an element excluding Li, Ni, Co and Mn.

5. The secondary battery according to claim 1,
wherein the positive electrode active material contains one or more elements selected from Zr and W, and
a content of the elements in the positive electrode active material is in a range of 0.1% by mole or more and 1.5% by mole or less.

6. The secondary battery according to claim 1,
wherein the electrolyte contains a nonaqueous solvent containing a fluorine-containing organic compound, and
a content of the fluorine-containing organic compound is in a range of 5% by volume or more and 15% by volume or less with respect to a total volume of the nonaqueous solvent.

7. The secondary battery according to claim 6,
wherein the fluorine-containing organic compound is fluoroethylene carbonate.
